(19) United States
(12) Patent Application Publication
(10) Pub. No.: US 2017/0007010 A1
(43) Pub. Date: Jan. 12, 2017

(54) Duo Liquid Dispersing Water Bottle for Pets or Persons

(71) Applicant: Warren Wayne Dybvig, Calgary (CA)

(72) Inventor: Warren Wayne Dybvig, Calgary (CA)

(21) Appl. No.: 14/611,278

(22) Filed: Feb. 2, 2015

(51) Int. Cl. A45F 3/16; C02F 1/00; A01K 7/00; B01D 29/00; B65D 43/02; B65D 39/16

(52) U.S. Cl. CPC A45F 3/16; B65D 43/0225; B65D 39/16; A01K 7/00; B01D 29/0095; C02F 1/002; A45F 2003/163; C02F 2307/02

(57) ABSTRACT

The invention is a single portable water bottle unit that delivers a convenient method of providing hydration to two separate parties. It consists of four main components; a lid, housing, a connector, and bowl. The components are connected to each other via threads and can be assembled and disassembled at anytime. The connector is responsible for controlling liquid flow via mechanical apparatus initiated through the compression of a button-trigger located on its side. When the button-trigger is compressed, liquid vacates through the bottom of the housing, through the connector, through a removable filter attached on the bottom of the connector, and finally into the bowl. The bowl enables a second party to consume the contents dispersed from the housing without having to consume from the same orifices as the first part, which fastens and unfastens to the bottom of the connector.

### WATER BOTTLE THEREFORE

This invention provides a method of supplying two entities with a means of consuming liquid, thus improving upon the traditional single entity serving water bottle.

### BACKGROUND OF THE INVENTION

Water bottles have long since been available as portable hydration devices. Traditional design dictates a two part system involving a fuselage and a lid. The fuselage (housing) is generally cylindrical, hollow on the inside, and elongated at the top creating a neck. This neck hosts the fuselage's only cavity. The lid seals the cavity preventing refuse and debris from entering and also counters liquid from exiting the main housing. Some water bottles have been redesigned to serve purposes other than, and/or additional to single user hydration.

| US - | U.S. Pat. No. | CA - | CA - | CA - | CA - | CA - |
|---|---|---|---|---|---|---|
| 2030146620 A1 | 8,272,351 B2 | 2689704 | 2585804 | 2286820 | 2689740 | 2538391 |
| Ghezelayagh | Hurwitz | Obayashi | Manjapra | Steinke | Andrews | Fick |

### SUMMARY OF INVENTION

Universally, water bottles are considered a personal item meant for individual usage, often consisting of two main components, a lid and a fuselage. The said invention consists of multiple pieces including; a lid, fuselage, connector, and bowl. The lid attaches to the fuselage by way of threads on the outside which connect to the inside threads of the fuselage. Liquid is housed in the fuselage which has openings on each end. Each end also possesses threading which contours the inside of each opening. The second opening, opposite the lid, is meant for the connector. The connector is threaded on the outside of each of its polar ends so it can securely fasten the fuselage and the bowl. It has a button trigger on the side, which when compressed, opens a gateway between the fuselage and the bowl within the connector allowing liquid to be dispersed through the connector's bottom. Threaded to the connector is the bowl which is used to deliver liquid to a second party. The top of the bowl is threaded to secure itself to the connector while the inside is hollow with a sealed bottom. It also has three notches on the bottom for grip leverage.

Drawings relaying the aforementioned summary,

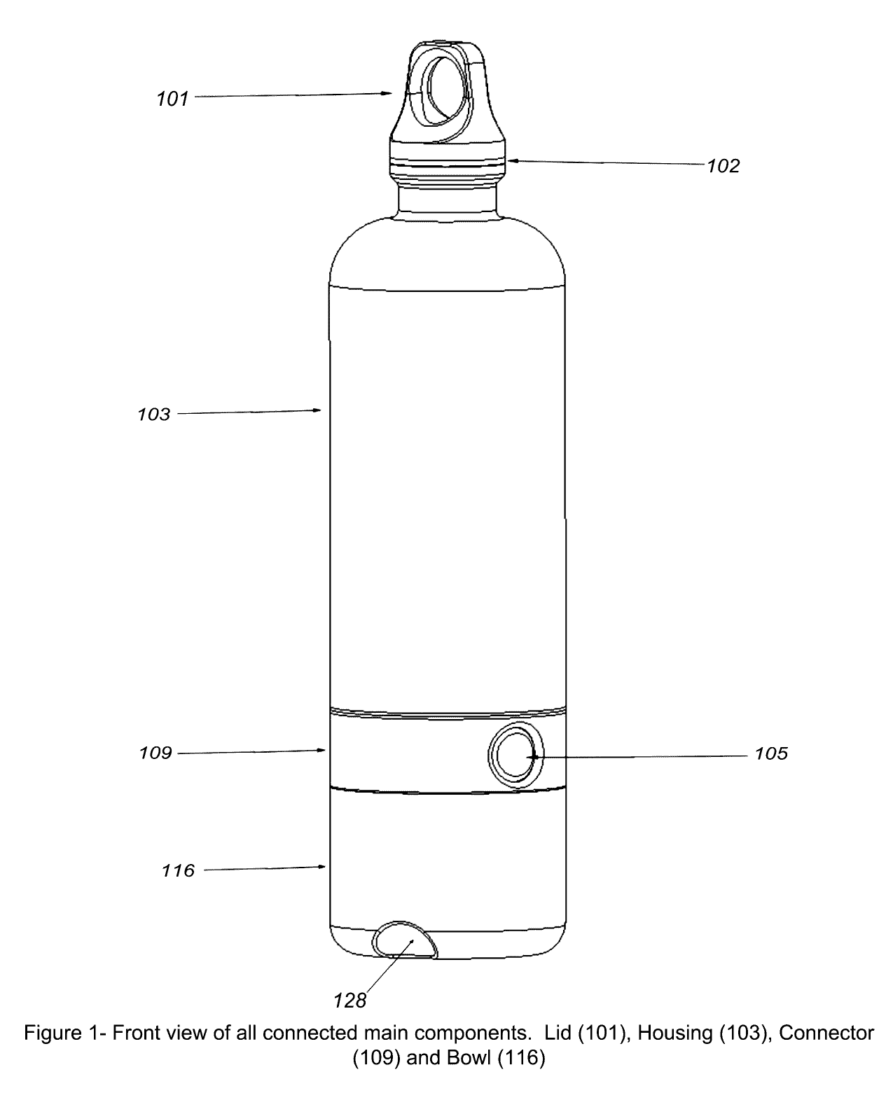

FIG 1. Side view of the bottle all parts attached including transparent view of the connector demonstrating the liquid control mechanics

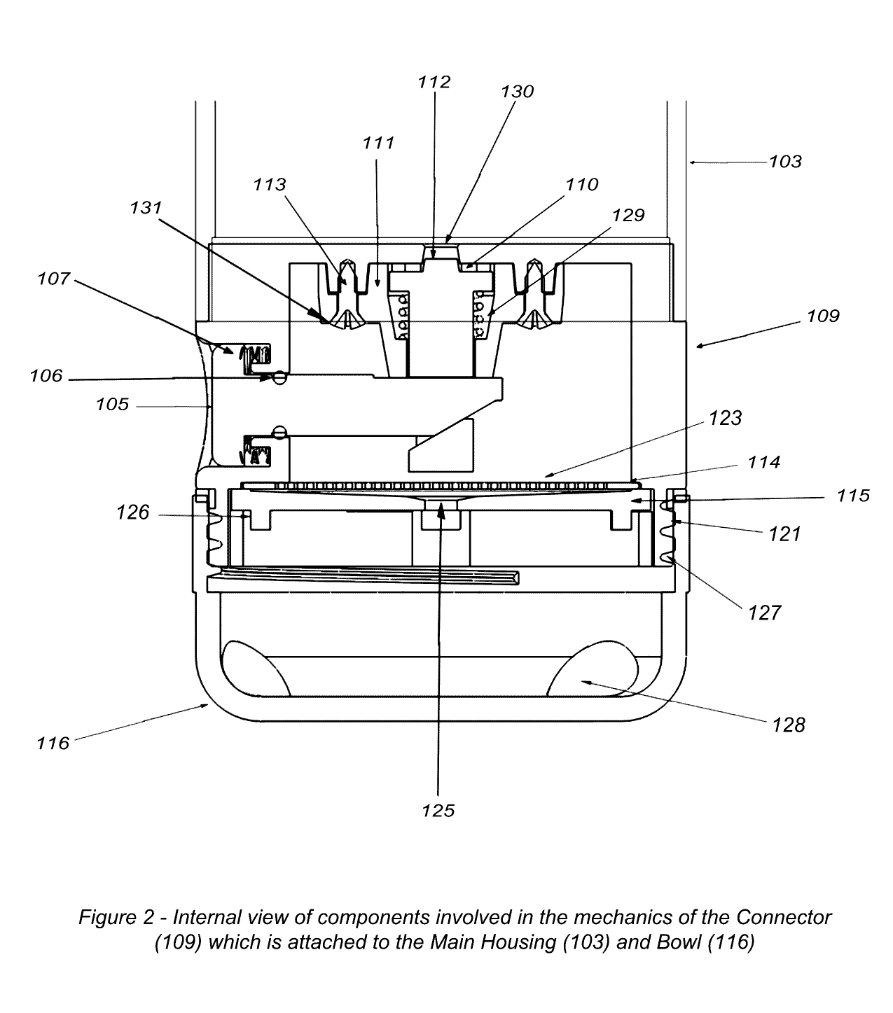

FIG. 2. Solid view of all parts connected at an angled perspective highlighting beveled notches on the bottom of bowl

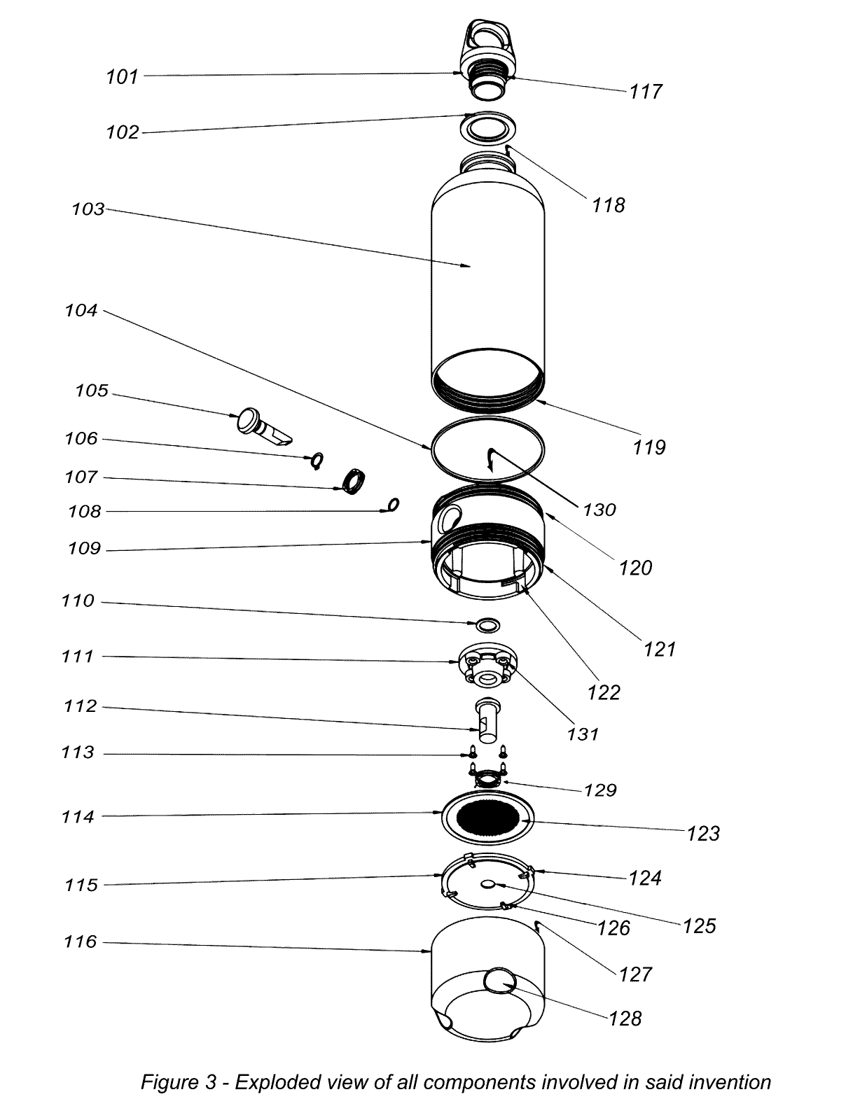

FIG. 3. View of mechanical functionality inside connector demonstrating compressed button opening valve on for liquid entry.

### DETAILED DESCRIPTION OF THE INVENTION

The benefit of the invention is the interaction, positioning, and order, of the components which collectively function to enable two parties to consume liquid; the lid, fuselage (housing), connector and bowl.

The lid connects to an extruded portion of the fuselage (neck), while the main part of the fuselage is attached to a connector, which itself is comprised of several moveable parts forming the mechanics of the liquid dispersal and impediment system. Attached to the bottom of the connector is the bowl, it has a convex exterior and concave interior. It is sealed on the bottom but open on top. All 4 components are connected by way of threading interlocking each component to the next. The strength of connectivity between each component depends on the amount of torque applied to one component while simultaneously applying torque in the opposite direction to the other component.

The lid represented in FIG. 4 section 1 connects to the fuselage and protects liquid from escaping through the cavity of the main part of the bottle. It encompasses the neck of the fuselage through threading located both inside the lid and outside on the extruded section of fuselage (neck). The lid also acts as a safety feature preventing refuse from entering the main part of the bottle where liquid is housed.

FIG. 4 section 2 and FIG. 6 section 1 shows the fuselage. It is cylindrical in shape with a hallow interior. Both ends are open with threads contouring the inside of each cavity. One cavity interlocks with the threads on the lid while the other interlocks with the threads of the connector.

The uniqueness of the connector, FIG. 4 section 3, FIG. 5, and FIG. 6 section 2, is the arrangement of parts which comprise the mechanics for controlling liquid impediment and dispersal within its shell. FIG. 5 section 1 shows the outside wall of the fuselage overlapping the threads of the connector. FIG. 5 section 2 and FIG. 6 section 2 is the shell of the connector. It has thread grooves on each polar end, is cylindrical in shape, and possesses a single cavity on the sidewall for securing the button-trigger. The bottom of the shell is open with four “L” grooves on the inside wall meant for locking the filter cap, FIG. 5 section 11 and FIG. 6 section 11, in place. FIG. 5 section 3 is the exterior of the detachable bowl, FIG. 4 section 4 and FIG. 6 section 3, which encompassed the outside of the connector's bottom threads. FIG. 5 section 4 and FIG. 6 section 4 is the button-trigger that interacts with the drain-plug, FIG. 5 section 6 and FIG. 6 section 9. It has an angular cut at the base of the shaft and a larger surface at the tip. The larger surface protrudes outside the connector's shell and is held in place via wave spring, section 8 FIG. 5 and FIG. 6 section 8, which is embedded within the cavity on the side of the shell. The wave-spring allows added resistance during compression and increased retraction power during release. When the wave-spring is completely retracted the button-trigger is sedentary. Sealing the residual space between the connector's side wall cavity and button-trigger is an o-ring, section 5 FIG. 5 and FIG. 6 section 12, which prevents any leakage during liquid dispersal. The drain plug, FIG. 5 section 6 and FIG. 6 section 9, impedes liquid from entering the connector from the fuselage when fixed in a static position. The drain-plug remains stationary due to the upwards force caused by the press-spring, FIG. 5 section 7 and FIG. 6 section 7, which pulls the drain-plug into a cavity located within the connector's ceiling. Retracting the drain-plug is accomplished by the interaction of the interconnecting right angles of the drain-plug and button-trigger. A downward force is applied to the drain-plug's angular stem by the angular stem of an increasingly compressed button-trigger, which retracts the drain-plug from the cavity. The body of the drain-plug consists of a tip, cap, and shaft. The size of the tip is dependent on the size of the connector's ceiling cavity. The cap, positioned in between the tip and shaft, prevents the drain-plug from retracting completely within the ceiling cavity interior. The shaft is solid with an opening towards the stem. The opening, which is angled at the bottom, allows the button-trigger to transfix itself through the drain-plug, thus enabling interaction of the two right angles. Four support screws FIG. 5 section 9 and FIG. 6 section 13, lock inside four holes on the corners of the drain-plug housing, FIG. 5 section 10 and FIG. 6 section 6, which append the drain-plug housing to the connector's ceiling. The drain-plug fits into the housing through the extruded hollow portion of its center. FIG. 5 section 12 and FIG. 6 section 10 is the removable filter which is secured to the inside bottom of the connector by way of filter cap, FIG. 5 section 11 and FIG. 6 section 11. The filter cap possesses a single cavity and has four protruding points that lock into “L” shaped divots on the inside of the connector's shell, FIG. 6 section 2. The filter cap is locked when the points are placed upwards inside the divots then turned sideways.

FIG. 4 section 4 and FIG. 6 section 3 detail the removable bowl that houses liquid for second party consumption. The bowl has a concave interior and a convex exterior with an open mouth and a sealed bottom. It attaches to the connector through interlocking threads located on the inside of its rim which overlap the threads on the bottom of the connector. The bottom of the bowl has three beveled notches adjacent to each other for better end-user leverage when holding/detaching/attaching.

The embodiments of the invention in which an exclusive property or privilege is claimed are defined as follows:

1. A bottle whereby several detachable components emerge into a single unit portable system which include;
A lid
Housing (fuselage)
A connector
A bowl

2. A combination of components from claim 1 wherein the connector appends both the housing and bowl.

3. From claim 2, where the connector is responsible for both impedance and dispersal of liquid from the housing to bowl through mechanical apparatus located within connector shell.

4. From claim 3, combination of interacting components comprising the mechanics within the connector shell;
A button-trigger with angular stem
A drain-plug with angular stem
A drain-plug stabilizer/housing
Filter
Filter cap

5. The combination of claim 4 components button-trigger and drain-plug possessing angled stems

6. From claim 5, the interaction of the button-trigger and drain plug, whereby the angled stem of button-trigger applies a sideward force, during button-trigger compression, to the angled stem of the drain-plug causing a downward force on the drain-plug.

7. From claim 6, the downward force removes the drain-plug from its position within the connector ceiling cavity allowing housing contents to disperse through connector's chassis.

8. From claim 4 the component combination of drain-plug stabilizer/housing attached to connector ceiling.

9. Combination of claim 4 components, connector and filter, wherein the inside bottom cavity of connector is covered by a filter.

10. Filter from claim 9 held in place byway of removable filter cap/stabilizer from claim 4 which affixes itself to connector via four points on its side interlocking with divots inside connector's bottom cavity.
